(19) United States
(12) Patent Application Publication
(10) Pub. No.: US 2006/0226025 A1
(43) Pub. Date: Oct. 12, 2006

(54) Electrochemical removal of die coatings

(75) Inventors: Brajendra Mishra, Golden, CO (US); John J. Moore, Evergreen, CO (US); Joe Matterson, Golden, CO (US)

Correspondence Address: SHERIDAN ROSS PC, 1560 BROADWAY, SUITE 1200, DENVER, CO, 80202, US

(73) Assignee: Colorado School of Mines, Golden, CO (US)

(21) Appl. No.: 11/378,440

(22) Filed: Mar. 16, 2006

Related U.S. Application Data
(60) Provisional application No. 60/662,756, filed on Mar. 16, 2005.

(51) Int. Cl. B23H 3/00

(52) U.S. Cl. 205/640

(57) ABSTRACT

Methods of uniformly removing coatings from metallic substrates, such as tools and dies, without damaging the surface of the underlying substrate are provided. The processes are optimized for steel substrates with metallic carbide or nitride coatings. The methods encompass aqueous electrochemical removal using stirred, low temperature, basic electrolytes. Following removal of an old coating, a new coating may be applied, allowing recycle and reuse of the underlying metal substrate. The ability to recoat and reuse tools represents a significant cost savings.

### CROSS REFERENCE TO RELATED APPLICATION

This application claims the benefit of priority under 35 U.S.C. § 119(e) to U.S. Provisional Patent Application Ser. No. 60/662,756, filed Mar. 16, 2005, which is incorporated herein in its entirety by this reference.

### FIELD OF THE INVENTION

The present invention relates to the removal of coating materials, and more particularly to the electrochemical removal of a coating from a metallic substrate.

### BACKGROUND OF THE INVENTION

Hard ceramic coatings impart specific tribological properties to metallic components and instruments such as machining tools, die core-pins, and high temperature devices. These hard coatings impart wear and abrasion resistance, reduce friction, enhance oxidation and corrosion resistance, and impart chemical inertness to the metal components to which they are applied. These protective mechanisms prolong the service life of tools while improving tool performance and reducing tooling costs. These coatings, however, can fail locally during use or due to mishandling, or may be lost at the end of the service life due to stress, lack of adhesion and/or wear.

Presently, when such coatings fail, the entire die or tool component is discarded even if the underlying metallic substrate had not been damaged. This represents an enormous tooling cost as most of the discarded tools and dies are high alloy steels and other non-ferrous, expensive super-alloys.

For this reason, the ability to recycle the underlying tool or die by removing a failed coating and replacing it with a new coating could drastically reduce the tooling costs of many research and commercial engineering enterprises. The selective local or general removal of a worn or failed tool coating without damaging the surface finish and shape of the substrate would be valuable for manufacturers and users of these tools and dies. The concept of reuse of valuable instruments can be of immense importance in several other applications where coatings are used for surface enhancement. On a production level, the ability to put components back in use after repair in a shorter timeframe has substantial economic benefits.

The microelectronics industry uses DC or RF plasma etching to remove layers of ceramic coatings such as titanium nitride and silicon oxide. This technique is, however, slow and requires specialized tooling. For these reasons, the plasma etching techniques are typically used to remove several hundred angstroms of these coatings. For planar surfaces, chemical-mechanical polishing (CMP) has also been employed. However, CMP is of limited use for the removal of coatings on non-planar surfaces. Therefore, an inexpensive and rapid method of reliably removing a coating from the metallic substrates is needed to overcome the deficiencies of known coating removal methods.

### SUMMARY OF THE INVENTION

The present invention is directed to a method and an apparatus for the electrochemical removal of coatings from metallic substrates, such as tools or dies. The present invention, for example, enables the resurfacing, recoating, and even repair of used metallic substrates, such as tools or dies, thereby greatly diminishing the costs associated with frequent discarding and replacement of the used substrates.

In accordance with one aspect of the present invention, there is a provided a method for substantially removing a coating from a metallic substrate. The method comprises passing a current over an electrochemical cell comprising an anode, a cathode, and an electrolyte.

The anode is typically the metallic substrate having a coating, and typically a surface coating. The coating on the substrate may comprise one or more layers. The cathode may be any metal suitable to function as a negative terminal or electrode through which electrons enter a direct current load in the cell. In one embodiment, the cathode is a platinum material. The electrolyte of the present invention is preferably an aqueous electrolyte and may include an acid or a base. Exemplary electrolytes for use in these methods include sulfuric acid, hydrochloric acid, nitric acid (aqua-regia) and sodium hydroxide. In one embodiment, the electrolyte contains sodium hydroxide in a concentration between about 0.01 M and about 3 M. In a particular embodiment, the electrolyte comprises about 0.1 M sodium hydroxide.

Passing a current over the electrochemical cell causes the dissolution of the coating. The metal substrate may be a metal tool, die, core-pin, and drill bit, or any planar or non-planar substrate. The coating may be a metallic carbide, a metallic nitride and combinations thereof, such as titanium-aluminum nitrides and/or chromium carbides.

In one embodiment, the electrolyte is stirred while a current is passed through the cell. Similarly, the anode may also be rotated while the current is passed through the cell. In one embodiment, the anode is rotated and simultaneously stirs the electrolyte.

It is also preferable to control the temperature of the electrolyte while the current is being passed through cell. Typically, the electrolyte is maintained at a temperature between about 25° C. and about 80° C., preferably between about 25° C. and 50° C., and more preferably is maintained at ambient temperature.

In one embodiment, the electrolyte in the cell is a basic solution, the anode is a steel instrument with a surface coating, and the surface coating is a ceramic coating.

In accordance with another aspect of the present invention, there is provided an electrochemical cell adapted for substantially removing a coating, and preferably a surface coating, of a metallic material comprising an anode, a cathode, and an aqueous electrolyte. The anode is the metallic material having a coating. The cathode may be any metal suitable to function as a negative terminal or electrode through which electrons enter a direct current load in the cell. In one embodiment, the cathode is a platinum material. The electrolyte of the present invention is preferably an aqueous electrolyte and may include an acid or a base. Exemplary electrolytes for use in these methods include sulfuric acid, hydrochloric acid, nitric acid (aqua-regia) and sodium hydroxide. In one embodiment, the electrolyte comprises sodium hydroxide in a concentration between about 0.01 M and about 3 M. In a particular embodiment, the electrolyte comprises about 0.1 M sodium hydroxide.

The electrochemical cell may also include peripheral equipment to facilitate the removal of the coating from the anode such as a device for rotating the anode, a device for stirring the electrolyte and/or a device for controlling the temperature of the electrolyte.

In one embodiment, the electrolytic cell contains a basic electrolyte solution, a steel instrument with a ceramic surface coating as the anode, and a platinum cathode.

### BRIEF DESCRIPTION OF THE DRAWINGS

FIG. 1 shows the Pourbaix's diagram for iron in water.

FIG. 2 depicts an apparatus for substantially removing a coating from a metallic substrate in accordance with the present invention.

FIG. 3a depicts a magnified image of the TiN/TiAlN/Cr coating on a die-casting core pin.

FIG. 3b depicts a magnified image through the layers of the die-casting core pin showing the TiN/TiAlN and CrC coating layers on the metal core pin.

FIG. 4 depicts a magnified image of the core pin following exposure to a solution of HCl—HNO₃ for 2 hours at 50° C.

FIGS. 5a-5b depict a magnified image of core pins following exposure to HCl—HNO₃; (a) 50% acid after 1 hour and, (b) 10% acid after 2 hours.

FIGS. 6a-d depict photomicrographs of core pins untreated or treated with a dilute solution of sodium hydroxide for varying lengths of time: (a) surface of an untreated core pin, (b) core pin after 10 hour exposure at 60° C. followed by 2 hour exposure at 80° C., (c) a core pin after 1 hour exposure at 50° C. and (d) a core pin after 4 hour exposure at 80° C.

FIG. 7 is a photomicrograph of a chromium carbide coating on a drill bit.

FIG. 8 depicts the drill bit after complete removal of the coating using the methods of this invention.

FIG. 9 is a photomicrograph of the drill bit following complete removal of the coating.

FIG. 10 depicts a magnified view of the cutting edge of the drill bit following removal of the CrC coating by methods of the present invention.

### DETAILED DESCRIPTION OF THE INVENTION

The present invention is directed to a method and apparatus for removing coatings on the surface of metallic substrates. The present invention enables the substantial removal and replacement of coatings, with the optional repair of the underlying instrument, to extend the life of the metallic substrate by as much as the original life of the coated metallic substrate. The present invention further provides easy and economical coating removal without expensive pulsed DC power supplies and without hydrogen embrittlement (because hydrogen only evolves on the cathode), with the consumption of only small amounts of power and the use of chemicals that can be safely used, cleaned and disposed.

In one embodiment of the present invention, there is provided a method of substantially removing a coating, and typically a surface coating, from an instrument by providing an electrochemical cell in which the anode is a metallic substrate with a coating. When a current is passed over the electrochemical cell comprising the anode, a cathode, and an electrolyte, the coating is effectively, economically, and substantially removed, and preferably completely removed, from the metallic substrate without damage to the underlying metallic substrate.

The metallic substrate may be of any planar or non-planar shape and may be of any length, width, or height. The metallic substrate may be completely composed of a metallic material or may be substantially composed of a metallic material. It is understood that the size or shape of the substrate of the metallic substrate having a surface coating is not limiting in the present invention as the methods or apparatus of the present invention may be scaled up or down as desired. It is only critical that the electrolyte has access to the coating. The present invention is particularly suitable for instruments, such as metal tools, dies, core-pins, drill bits and the like, having a coating. The instruments may have complex non-planar shapes so long as the coating targeted for removal has access to an electrolyte in the electrochemical cell.

Typically, the coating is a surface coating and includes a metallic carbide or nitride coating such as a titanium-aluminum nitride, chromium carbide or combinations thereof. The coating may partially, substantially, or completely cover the metallic substrate or material.

The cathode of the cell can be any metal suitable to function as the negative terminal or electrode through which electrons enter a direct current load in the cell. Preferably, the cathode is a platinum cathode.

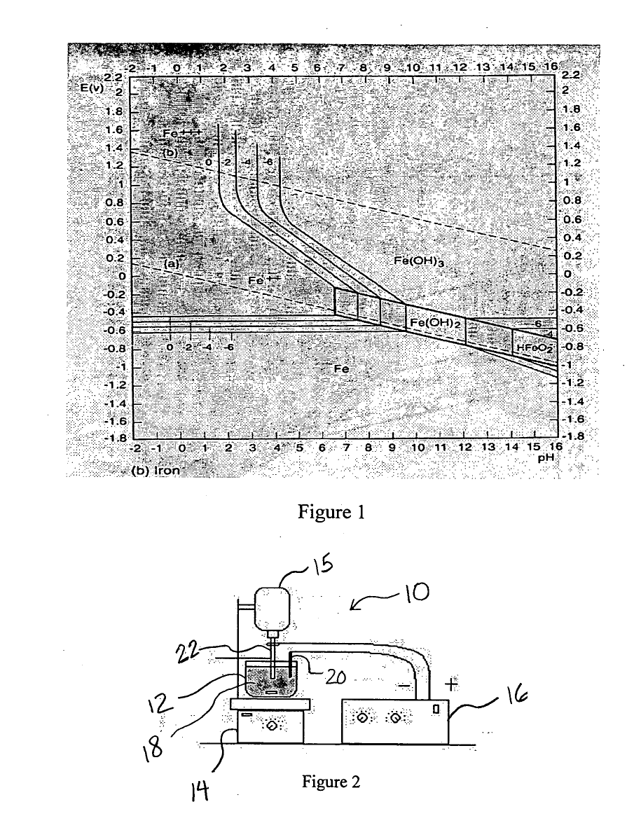

The electrolyte is preferably an aqueous solution and may contain a suitable acid, such as sulfuric acid, hydrochloric acid, nitric acid (aqua-regia) or a base, such as sodium hydroxide. Preferably, the electrolyte is a basic solution because ceramics and metals are generally attacked in acidic solutions while metals usually passivate in basic solutions and ceramics dissolve as anions in basic solutions. Thus, using the processes and apparatuses of the present invention, ceramic coatings particularly on metallic substrates will preferentially be dissolved without damage to the underlying substrate. FIG. 1 shows a potential-pH diagram for an iron-water system that illustrates this strategy. The diagram shows the large passive region for iron oxides in the basic solutions but dissolution in acidic solutions. Preferably, the electrolyte is stirred within the electrochemical cell during the removal of the coating to facilitate even, thorough, and substantial or complete removal of the coating.

In one embodiment, the electrolyte is a dilute sodium hydroxide solution. Preferably, the electrolyte of this embodiment is a sodium hydroxide solution having a concentration between about 0.01M and about 3M, preferably between about 0.05 M and 1 M, and more preferably about 0.1 M.

In one embodiment, the anode is rotated during the application of the current to the electrochemical cell. In this way, the coating is evenly removed from the metallic substrate forming the anode of the electrochemical cell and the electrolyte is beneficially stirred and circulated in the cell.

The temperature of the electrochemical cell and specifically of the electrolyte during the electrochemical removal of the coating is typically between about 15° C. and about 100° C. Generally, as the temperature of the electrolyte increases, the coating is more quickly removed from the metallic substrate. However, the use of a higher temperature requires additional energy in the process and can lead to surface damage to the instrument under the coating at very high temperatures. Thus, a preferred temperature range of the electrolyte during the electrochemical removal process is between about 20° C. and about 80° C., more preferably between about 25° C. and about 50° C., and further preferably about ambient temperature.

Any suitable heating apparatus can be used to maintain the electrolyte at an elevated temperature during the electrochemical removal process. In one embodiment, a heating pad or a hot plate is used to heat the container of electrolyte during the coating removal process.

The removal of coatings may be detected and monitored through changes in the cell's current at a fixed voltage. The time for the substantial or complete electrochemical removal of the coating overlaying the metallic substrate may depend upon the size of the instrument, the composition and thickness of the coatings, the size and shape of the metallic substrate, as well as the size of the electrochemical cell used and the amount of current applied. Additionally, the composition of the electrolyte used and the temperature of the electrolyte during the process will affect the time needed to substantially or completely remove the coating as described above. However, for smaller metallic articles, such as dies and drill bits, the coating may be typically removed in less than about 20 hours and more typically, less than about 10 hours. In one embodiment, the electrochemical removal of a coating from a metallic material is conducted over a period of between about 5 minutes and about 4 hours.

In one embodiment, an optional substrate washing and cleaning step follows the electrochemical removal of the surface coating.

Referring to FIG. 2, an apparatus 10 for carrying out the methods of the present invention is shown as including a container 12, which is preferably chemically inert, a hot plate 14, a motorized rotating device 15, a power supply 16, an electrolyte 18, and electrodes (reference and working), i.e. a platinum cathode 20 and a metallic material with a coating 22, which may be a surface coating. The power supply 16 may further include a low voltage-low amp.

The dimensions of the cell can be determined and fabricated by the user based on throughput requirements as would be appreciated by one skilled in the art. The anode is the metallic material having a coating 22. In one embodiment, the cathode is a platinum material, as in platinum cathode 20. Alternatively, the cathode may be any metal suitable to function as a negative terminal or electrode through which electrons enter a direct current load in the cell.

The electrolyte of the present invention is preferably an aqueous electrolyte and may include an acid or a base. Exemplary electrolytes for use in these methods include sulfuric acid, hydrochloric acid, nitric acid (aqua-regia) and sodium hydroxide. In one embodiment, the electrolyte comprises sodium hydroxide in a concentration between about 0.01 M and about 3 M. In a particular embodiment, the electrolyte comprises about 0.1 M sodium hydroxide.

In one embodiment, apparatus 10 includes any suitable device that can stir the electrolyte during the removal process and any suitable device to rotate the substrate electrode (anode) during the process. For example, motorized rotating device 15 can both rotate the anode and simultaneously stir the electrolyte.

This present invention enables an easy, fast, inexpensive, safe and effective operation, and enables the use of existing environmental procedures for clean up and disposal of used acids/organics.

Additional objects, advantages, and novel features of this invention will become apparent to those skilled in the art upon examination of the following examples thereof, which are not intended to be limiting.

### EXAMPLES

Experimental Configuration: A 10V-3 amp DC power supply was used to power the electrolytic cell. A motorized rotating device was employed to hold the rotating anode, which also served as the stirrer. Electrical connection to the rotating anode was made through a de-coupler. Platinum wire was used as the cathode. A hot-plate was used to heat the electrolyte and to control the temperature. The pH was monitored during the experiment. The removal of coating was detected through a change in current at a fixed voltage.

### Example 1

### TiAlN Coatings

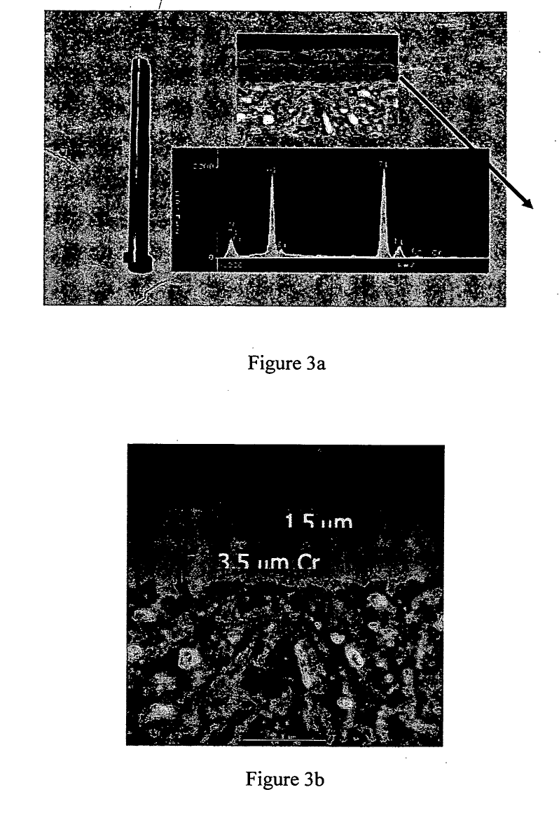

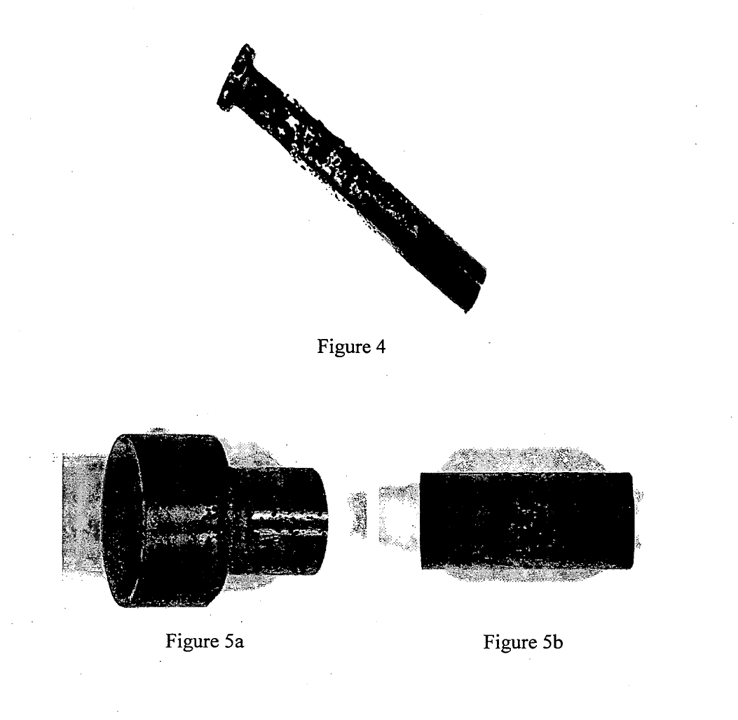

A coating of 1.5 mm of graded TiN/TiAlN over 3.5 mm e-Cr (as shown in FIGS. 3a 3b) was dissolved in both an aqua-regia and a sodium hydroxide electrolyte solution. FIG. 4 shows the sample after exposure to aqua-regia (3:1 HCl—HNO₃) for 2 hours at 50° C. The figure shows that the coating was been severely attacked and local pitting caused dissolution of the substrate. The acid concentration was decreased to 50% and further to 10%. The test temperature was lowered to 30° C. The diluted acid still pitted the substrate at lower temperatures as shown in FIGS. 5a-5b. FIGS. 5a-5b depict a magnified image of core pins following exposure to HCl—HNO₃; (a) 50% acid after 1 hour and, (b) 10% acid after 2 hours.

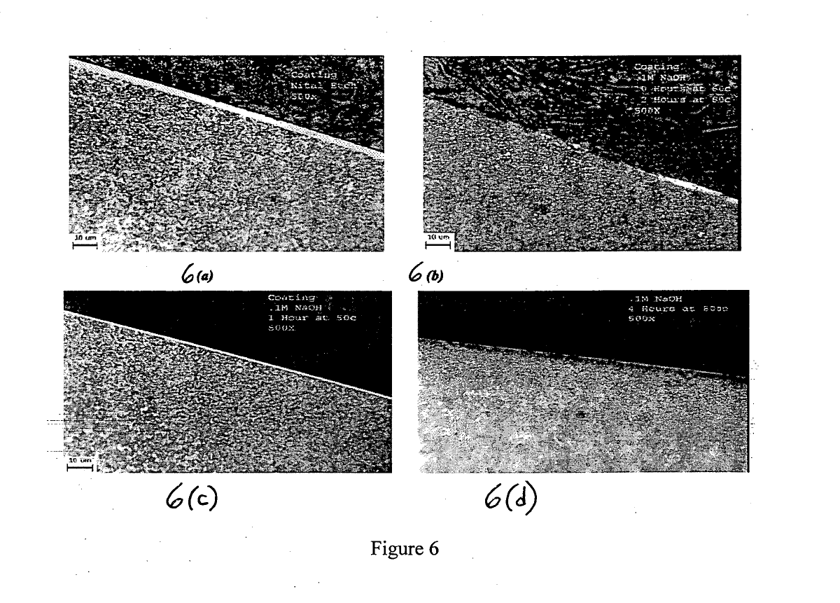

The electrolytic solution was changed to 0.1 M sodium hydroxide and chemical dissolution was conducted for various lengths of time at different temperatures. In each trial, the electrolyte solution was stirred and the samples were rotated. FIG. 6a shows the original sample with the TiAlN coating. FIG. 6c shows a uniform removal after 1 hour at 50° C. FIG. 6b shows the removal of the coating from the metallic substrate after 10 hours of exposure at 60° C. followed by 2 hours at 80° C. and FIG. 6d shows complete removal after 4 hours of exposure at 80° C. These results showed that a higher temperature of above 80° C. was successful for removal of this coating from this instrument. It was also observed that the ceramic TiN/TiAlN was removed quickly while the electroplated chromium layer was slow to dissolve. Based on the chemical dissolution data in the basic solution, the electrolytic removal was attempted in the same solution and at a lower temperature of 50° C. Complete removal of nitride coating was obtained under the optimized conditions of an applied potential of between 12 volts and 15 volts, a temperature of about 50° C., a stirred electrolyte solution of about 0.1 M NaOH and an anodic current density between 2.5 and 3.0 A/cm². The time for complete removal of this coating was about 10 minutes for a 5 micron coating (3.5 micron chromium+1.5 micron TiAlN).

### Example 2

### CrC Coatings

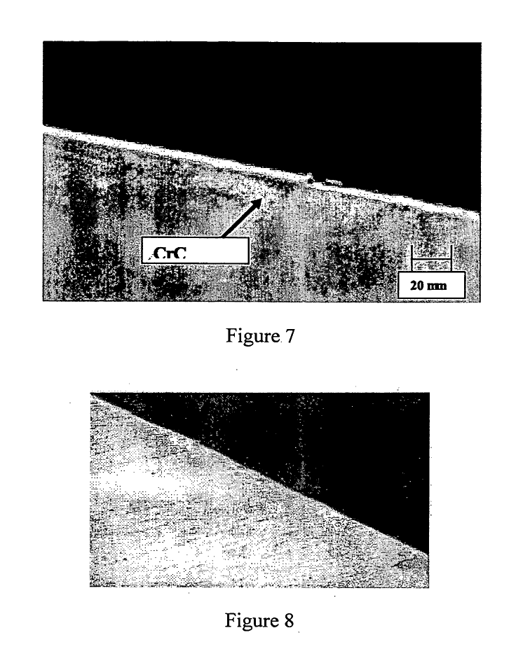

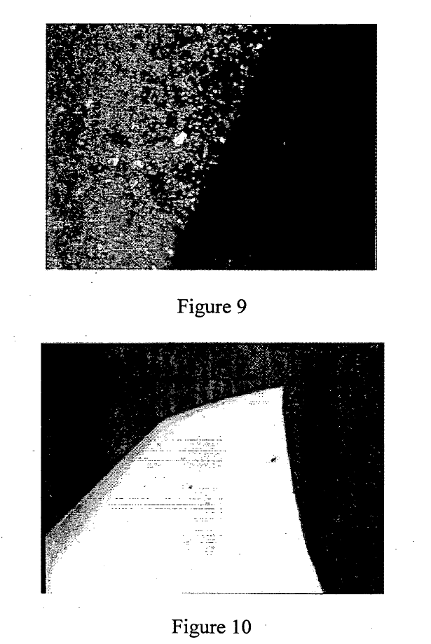

A coating of approximately 7.5 mm of chromium carbide on a drill bit is shown in FIG. 7. For the removal of chromium carbide, a basic solution of 0.1 M NaOH was used as the electrolyte and a temperature of 80° C. was used under the same configuration of electrode stirring described in Example 1. Platinum wire was used as the cathode and the coated drill bit served as the anode. FIG. 8 shows the drill bit after complete removal of coating. To further optimize the removal process, the electrolyte temperature was dropped to 50° C. and further to about 25° C. (ambient temperature). It was found that the coating could be removed in a time between about 5 minutes to about 90 minutes duration depending on the temperature. FIG. 9 shows the clean surface prepared at room temperature. The surface profile shows that the substrate had not been affected. FIG. 10 indicates that the cutting edge of the drill bit was still sharp. No evidence of local attack or pitting was seen on the surface after coating removal. Based on these results, the optimized conditions for a CrC coating removal in the experimental configuration were an applied potential of 10 volts, a temperature of about 25° C., a stirred aqueous electrolyte solution of about 0.1 M NaOH and an anodic current density of 1.0 A for a time of about 90 minutes for a 7.5 micron CrC coating.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described hereinabove are further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A method of substantially removing a coating from a metallic substrate, comprising:
passing a current over an electrochemical cell, said cell comprising an anode, a cathode, and an electrolyte, wherein the anode is the metallic substrate having the coating, and wherein the current causes the dissolution of the coating from the metallic substrate.

2. The method of claim 1, wherein the metallic substrate is at least one of a metal tool, die, core-pin, and drill bit.

3. The method of claim 1, wherein the surface coating is selected from the group consisting of a metallic carbide, a metallic nitride and a combinations thereof.

4. The method of claim 3, wherein the coating is selected from the group consisting of titanium-aluminum nitride, chromium carbide and combinations thereof.

5. The method of claim 1, wherein the electrolyte is stirred during the passing of said current step.

6. The method of claim 1, wherein the anode is rotated during the passing of said current.

7. The method of claim 1, wherein the electrolyte is an aqueous electrolyte.

8. The method of claim 7, wherein the electrolyte comprises at least one of an acid and a base.

9. The method of claim 8, wherein the electrolyte comprises a compound selected from the group consisting of sulfuric acid, hydrochloric acid, nitric acid (aqua-regia) and sodium hydroxide.

10. The method of claim 8, wherein the electrolyte comprises sodium hydroxide in a concentration between about 0.01 M and about 3 M.

11. The method of claim 10, wherein the electrolyte comprises sodium hydroxide in a concentration of about 0.1 M.

12. The method of claim 1, wherein the electrolyte is maintained at a temperature between about 25° C. and about 50° C. during the passing of said current.

13. The method of claim 1, wherein the passing of said current is conducted for less than about 10 hours.

14. The method of claim 1, wherein the electrochemical cell comprises a platinum cathode.

15. The method of claim 1, wherein the electrolyte is a basic solution, the anode is a steel instrument and the surface coating is a ceramic coating.

16. An electrochemical cell adapted for substantially removing a coating of a metallic material, comprising: an anode, a cathode, and an aqueous electrolyte, wherein the anode is a substantially metallic material having a coating.

17. The electrochemical cell of claim 16, wherein the cathode is a platinum cathode.

18. The electrochemical cell of claim 16, wherein the electrolyte comprises at least one of an acid and a base.

19. The electrochemical cell of claim 18, wherein the electrolyte comprises sodium hydroxide in an amount of from about 0.01 M to about 3 M.

20. The electrochemical cell of claim 18, wherein the electrolyte comprises a compound selected from the group consisting of sulfuric acid, hydrochloric acid, nitric acid (aqua-regia) and sodium hydroxide.

21. The electrochemical cell of claim 16, further comprises at least one of a means for rotating the anode, a means for stirring the electrolyte and a means for controlling the temperature of the electrolyte.

22. The electrochemical cell of claim 21, wherein the means for rotating the anode and the means for stirring the electrolyte is a motorized rotating device.

23. The electrochemical cell of claim 21, wherein the means for controlling the temperature of the electrolyte is at least one of a hot plate and a heating pad.

24. The electrochemical cell of claim 16, wherein the electrolyte is a basic solution, the anode is a steel instrument, the cathode is a platinum cathode and the surface coating is a ceramic coating.

25. The electrochemical cell of claim 15, wherein the surface coating is selected from the group consisting of titanium-aluminum nitride, chromium carbide and combinations thereof.
